(19) United States
(12) Patent Application Publication
(10) Pub. No.: US 2026/0164134 A1
(43) Pub. Date: Jun. 11, 2026

(54) FLICKER COMPENSATION IN HIGH DYNAMIC RANGE IMAGE PROCESSING

(71) Applicant: QUALCOMM Incorporated, San Diego, CA (US)

(72) Inventors: Vamshi Krishna Reddy ANIREDDY, Karimnagar (IN); Soman Ganesh NIKHARA, Hyderabad (IN); Yagnesh BADIYANI, Hyderabad (IN); Mahesh KATTA, Nizamabad (IN); Manivas KANDUKURI, Siddipet (IN)

(21) Appl. No.: 18/974,416

(22) Filed: Dec. 9, 2024

(51) Int. Cl. H04N 23/741; H04N 23/71; H04N 23/73; H04N 23/745

(52) U.S. Cl. CPC H04N 23/741; H04N 23/71; H04N 23/73; H04N 23/745

(57) ABSTRACT

Systems and techniques are described herein for processing image data. For example, a computing device can obtain a first image associated with a first exposure value and a second image associated with a second exposure value, wherein the second exposure value is greater than the first exposure value; generate a map including a plurality of values indicating a relationship between a first plurality of pixel values of the first image and a second plurality of pixel values of the second image; determine a region of the second image associated with at least one value in the map below a predetermined threshold; modify, based on the determined region of the second image, one or more pixel values associated with a region of the first image corresponding to the region of the second image; process the first image and the second image to generate a blended image.

### TECHNICAL FIELD

The present disclosure generally relates to image processing. For example, aspects of the present disclosure relate to systems and techniques for performing high dynamic range (HDR) flicker compensation (e.g., compensating for static and rolling flicker in images captured using various exposure durations).

### BACKGROUND

High dynamic range (HDR) imaging is a technique that can use multiple image frames of varying exposure durations (or lengths) to generate an image that depicts both dark portions and light portions of a scene with a level of detail intended to resemble what the human eye can perceive in real life. Cameras, among other devices, can use an image sensor to capture the multiple image frames. Many cameras can capture the multiple image frames using varying exposure settings based on environmental lighting. For example, some cameras can capture image frames in bright environments using an exposure setting associated with a short exposure duration and can capture image frames in darker environments using an exposure setting associated with a longer exposure duration. Some cameras, such as cameras equipped to perform various HDR imaging techniques, can capture images using longer exposure durations and shorter exposure durations. For example, some cameras can include a processor such as an image signal processor (ISP) to perform various HDR imaging techniques.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for processing image data is provided. The apparatus can include at least one memory and at least one processor coupled to the at least one memory configured to: obtain a first image associated with a first exposure value and a second image associated with a second exposure value, wherein the second exposure value is greater than the first exposure value; generate a map including a plurality of values indicating a relationship between a first plurality of pixel values of the first image and a second plurality of pixel values of the second image; determine a region of the second image associated with at least one value in the map below a predetermined threshold; modify, based on the determined region of the second image, one or more pixel values associated with a region of the first image corresponding to the region of the second image; process, using the modified one or more pixel values, the first image and the second image to generate a blended image; and output the blended image.

In some aspects, a method for processing image data is provided. The method can include: obtaining a first image associated with a first exposure value and a second image associated with a second exposure value, wherein the second exposure value is greater than the first exposure value; generating a map including a plurality of values indicating a relationship between a first plurality of pixel values of the first image and a second plurality of pixel values of the second image; determining a region of the second image associated with at least one value in the map below a predetermined threshold; modifying, based on the determined region of the second image, one or more pixel values associated with a region of the first image corresponding to the region of the second image; processing, using the modified one or more pixel values, the first image and the second image to generate a blended image; and outputting the blended image.

In some aspects, a non-transitory computer-readable medium is provided having stored thereon instructions that, when executed by at least one processor, cause the at least one processor to: obtain a first image associated with a first exposure value and a second image associated with a second exposure value, wherein the second exposure value is greater than the first exposure value; generate a map including a plurality of values indicating a relationship between a first plurality of pixel values of the first image and a second plurality of pixel values of the second image; determine a region of the second image associated with at least one value in the map below a predetermined threshold; modify, based on the determined region of the second image, one or more pixel values associated with a region of the first image corresponding to the region of the second image; process, using the modified one or more pixel values, the first image and the second image to generate a blended image; and output the blended image.

In some aspects, an apparatus of for processing image data is provided. The apparatus can include: means for obtaining a first image associated with a first exposure value and a second image associated with a second exposure value, wherein the second exposure value is greater than the first exposure value; means for generating a map including a plurality of values indicating a relationship between a first plurality of pixel values of the first image and a second plurality of pixel values of the second image; means for determining a region of the second image associated with at least one value in the map below a predetermined threshold; means for modifying, based on the determined region of the second image, one or more pixel values associated with a region of the first image corresponding to the region of the second image; means for processing, using the modified one or more pixel values, the first image and the second image to generate a blended image; and means for outputting the blended image.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF FIGURES

Illustrative examples of the present application are described in detail below with reference to the following figures:

FIG. 1 is a block diagram illustrating an example architecture of an image processing system, in accordance with some examples of the present disclosure;

FIG. 2 illustrates multiple images with different exposures used to create a fused high dynamic range image, in accordance with some examples of the present disclosure;

FIG. 3 is a block diagram illustrating an example system for generating an HDR image, in accordance with aspects of the present disclosure;

FIG. 4 is a block diagram illustrating an example flicker correction engine for flicker gain map estimation, in accordance with aspects of the present disclosure;

FIG. 5 is a block diagram illustrating an example system for flicker compensation of HDR images, in accordance with aspects of the present disclosure;

FIG. 6A is a diagram illustrating an example of a frame of a sequence of frames, in accordance with aspects of the present disclosure;

FIG. 6B is a diagram illustrating an example of a frame that is adjacent to the frame of FIG. 6A in the sequence of frames, in accordance with aspects of the present disclosure;

FIG. 7 is a block diagram illustrating flicker compensation of an image, in accordance with aspects of the present disclosure;

FIG. 8 is a process a flow diagram for processing image data, in accordance with aspects of the present disclosure;

FIG. 9 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with camera hardware to capture image frames, such as still images and/or video frames, for consumption. For example, an electronic device can include a camera to allow the electronic device to capture a video or image of a scene, a person, an object, etc. A camera is a device that receives light and captures image frames (e.g., still images or video frames) using an image sensor. In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, an electronic device implementing a camera can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Moreover, cameras can be configured with a variety of image capture and image processing settings to alter the appearance of an image. Some camera settings can be determined and applied before or while an image is captured, such as ISO, exposure time (also referred to as exposure, exposure duration, or exposure length), aperture size, f/stop, shutter speed, focus, and gain, among others. Some camera settings can be configured for post-processing of an image, such as alterations to a contrast, brightness, saturation, sharpness, levels, curves, and colors, among others. In some examples, a camera can be configured with certain settings to adjust the exposure of an image captured by the camera.

In photography, the exposure of an image captured by a camera refers to the amount of light per unit area that reaches a photographic film, or in modern cameras, an electronic image sensor. The exposure is based on certain camera settings such as, for example, shutter speed, exposure time, and/or lens aperture, as well as the luminance of the scene being photographed. Many cameras are equipped with an automatic exposure or “auto exposure” mode, where the exposure settings (e.g., shutter speed, exposure time, lens aperture, etc.) of the camera may be automatically adjusted to match, as closely as possible, the luminance of a scene or subject being photographed. In some cases, an automatic exposure control (AEC) engine can perform AEC to determine exposure settings for an image sensor.

In photography and videography, a technique called high dynamic range (HDR) allows the dynamic range of image frames captured by a camera to be increased beyond the native capability of the camera. In this context, a dynamic range refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames with the different exposures into a single image frame. The combination of image frames with different exposures can result in an image with a dynamic range higher than that of each individual image frame captured and combined to form the HDR image frame. For example, the electronic device can create a high dynamic range scene by fusing two or more exposure frames into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

An imaging device can generate a high dynamic range (HDR) image by merging multiple images that captured with different exposure settings. For instance, an imaging device can generate an HDR image by merging together a short-exposure image captured with a short exposure time, a medium-exposure image captured with a medium exposure time that is longer than the short exposure time, and a long-exposure image captured with a long exposure time that is longer than the medium exposure time. As another example, the imaging device can create an HDR image using a short-exposure image and a long-exposure image.

Because short-exposure images are generally dark, they generally preserve the most detail in the highlights (bright areas) of a photographed scene. Medium-exposure images and the long-exposure images are generally brighter than short-exposure images, and may be overexposed (e.g., too bright to make out details) in the highlight portions (bright areas) of the scene. Because long-exposure images generally include bright portions, they may preserve detail in the shadows (dark areas) of a photographed scene. Medium-exposure images and the short-exposure images are generally darker than long-exposure images, and may be underexposed (e.g., too dark to make out details in) in the shadow portions (dark areas) of the scene, making their depictions of the shadows too dark to observe details. To generate an HDR image, the imaging device may, for example, use portions of the short-exposure image to depict highlights (bright areas) of the photographed scene, use portions of the long-exposure image depicting shadows (dark areas) of the scene, and use portions of the medium-exposure image depicting other areas (other than highlights and shadows) of a scene.

HDR image quality can be improved (e.g., less distortion, improved clarity, etc.) based on improvements to systems and techniques of blending long-exposure images and short-exposure images using a motion map. Traditional HDR solutions rely primarily on motion map estimation to determine an appropriate exposure frame for each pixel, especially when there is a discrepancy in image content between long and short exposures. The HDR solutions generally select an anchor exposure to handle regions with motion. The anchor exposure generally closer to the short exposure frame to reduce motion blur. The use of anchor exposure allows for capturing moving objects with greater clarity by selecting pixels from the short exposure frame, which has less motion blur due to a shorter exposure time.

Motion estimation logic in hardware, such as motion estimation using Mean Absolute Difference (MAD) between pixels in exposure-compensated frames, can encounter significant issues from flicker artifacts occurring due to variation in illumination intensity. For example, the variation in illumination intensity can be due to a rolling shutter mechanism. The flicker artifacts can cause high differences between flickered short exposure images and unflickered long exposure images, even in static regions (e.g., images without motion). The flicker artifacts can cause incorrect identification of static regions as including motion, leading to an over-reliance on the anchor frame during blending. The misidentification of motion reduces quality of images generated during the HDR processes, because the motion map fails to accurately distinguish between motion and static regions.

Correction of flicker before processing of images using motion estimation allows for the HDR process to select an exposure frame more accurately because of the images used during the HDR process are not misidentified as including motion. By removing the flicker artifacts, the motion estimation logic can differentiate between motion and static regions. The flicker correction can allow the HDR solution to select the exposure frame more accurately, resulting in an image with a better dynamic range and improved Signal-to-Noise Ratio (SNR). Additionally, our approach offers flexibility in the final blending process. Users can choose to blend using either the flicker-corrected short exposure or the original flickered short exposure, depending on their preference and a desired outcome. The adaptability can allow the HDR solution to cater to varying user needs and preferences, providing a superior imaging experience.

An HDR block can use the corrected short and long exposures for blending. In some examples, the HDR block can use the original flickered-short and flicker-free long exposures for blending, and perform motion estimation on the flicker-corrected short exposure. The approach can result in an accurate motion map, leading to improved blending outcomes. By addressing flicker artifacts in the motion estimation phase, our solution ensures that true motion regions are identified, enhancing the overall dynamic range and image quality.

In some examples, the correction algorithm operates on a per-pixel basis. Occasionally, inaccuracies in correction estimates may introduce unnatural artifacts into the short exposure image, which could propagate into the blended output. To mitigate the artifacts, some users may prefer to use the original flickered short exposure. However, traditional HDR techniques treat flicker as motion, causing flickering pixels to appear throughout the image. Distinguishing between flicker and motion ensures actual moving regions are identified as motion, preventing static regions from being incorrectly processed.

Flicker can refer to perceptible changes in brightness (e.g., light intensity) or color of pixels of an image. Flicker may occur in images or videos when there are inconsistencies in frame rates, refresh rates, and/or lighting conditions. In HDR imaging, flicker can arise from variances between multiple shots and from rolling shutter effects in cameras. Flicker can be especially evident under fluctuating light sources. Many light sources fluctuate at a rate imperceptible to many human observers. For example, lights fluctuate based on their source of power. In the United States, the standard electrical frequency is 60 Hz. While drivers can convert electrical frequency of alternating current (AC) power to direct current (DC) power, the drivers often fail to provide a fully smooth conversion which can still result in fluctuations in intensity of light sources. The fluctuations generally are not perceptible to humans; however, cameras and other image sensors often do capture the fluctuations when filming or photographing subjects exposed to the fluctuating light sources.

Flicker, such as flicker resulting from fluctuations in light sources, can be visible in an image or video as an artifact. A common artifact can include bands of varying light intensity of pixels (vertical or horizontal bands depending on the image sensor) which can be visible on an image or in a video. Flicker due to AC powered lighting source can be mitigated by configuring exposure times of images to be a multiple of banding times. For example, in 50 Hz (e.g., Japan, Europe, etc.) lighting conditions, setting the exposure times for images captured by an image sensor to be multiple of 10 ms. i.e., 10 ms or 20 ms or 30 ms can mitigate flicker due to AC powered lighting sources. In 60 Hz (e.g., United States, Canada, etc.) lighting conditions, setting the exposure time to be a multiple of 8.333 ms. i.e., 8.333 ms or 16.666 ms or 25 ms can mitigate flicker due to AC powered lighting sources. The banding time is half the electrical current's time period of the light source. For example, 50 Hz can be represented as an electrical time period of 20 ms. In such an example, the banding time is 10 ms.

However, at higher frames per second (e.g., FPS>120), flicker becomes inevitable due to less frame time which in turn restricts the exposure time. Artifacts such as rolling bands occur when an exposure time (e.g., 1/FPS) is not a multiple of light source banding time (e.g., 1/frequency such as 1/100 Hz, 1/120 Hz, etc.). Artifacts such as static bands can occur when frame duration is a multiple of a banding time and exposure time is not a multiple of banding time. When a light source fluctuates during an exposure (e.g., exposure setting of an image sensor), the temporal variation of the light intensity across pixels of an image can be represented as a spatial variation by the image sensor. The spatial variation can be due to the exposure delay among pixel rows when capturing the image, leading to “band”-like (e.g., visual appearance of a band/bar over a portion of an image) spatial intensity distortion of the image, the distortion also referred to as flicker. Line frequency and rolling shutter of an image sensor both contribute to the distortion (e.g., the flicker) of the image.

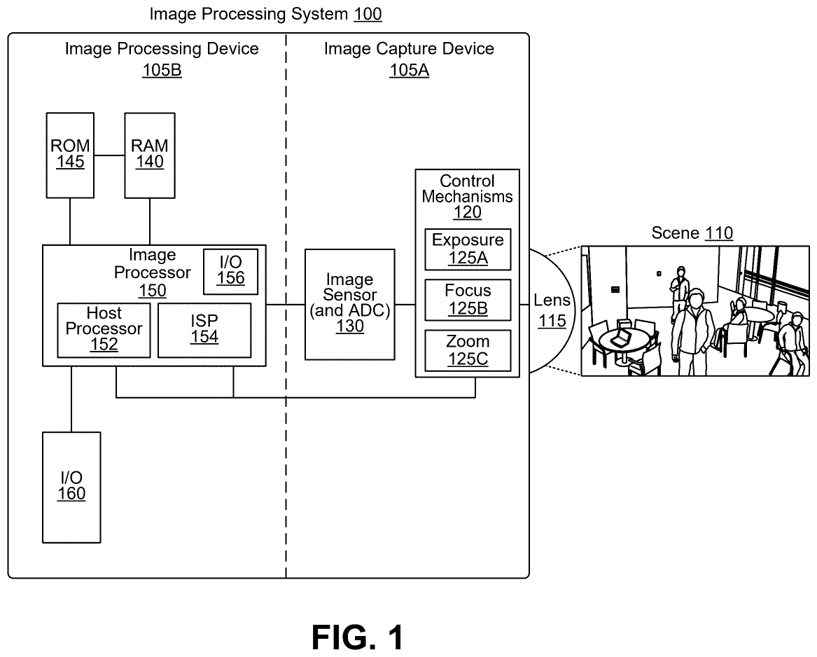

As previously described, and further described in description of FIG. 1-FIG. 3, HDR can include the merging of multiple images captured with different exposure settings. Flicker is generally more evident in images with shorter exposure settings at least because the shorter exposure setting less likely to be configured as a multiple of banding time. When the exposure time is not configured as a multiple of banding time, the bands are prone to occur. Flicker can also be observed in scenes where a subject of an image is exposed to both natural light (e.g., the sun) and artificial light (e.g., LEDs, fluorescent light, etc.) or multiple light sources with different light intensities (e.g., a first LED and a second LED with different light intensities). Systems and techniques that compensate for the flicker can produce higher quality images with fewer unwanted artifacts (e.g., static or rolling bands).

Current HDR systems and techniques are unable to distinguish between flicker and motion. For example, many HDR systems and techniques mistake flicker for motion, and incorrectly use images with shorter exposure durations to correct for the mistaken motion. Most of the present HDR solution relay on motion map estimation for blending of long and short exposure. The dependency is because present HDR solutions select the correct exposure frame to pick a pixel. Many solutions use an exposure referred to as the anchor exposure to determine motion. In an example with a person moving his or her hand in a frame, the short and long can have mismatches in pixels, the HDR solution prefers to take that pixel from short exposure because the short exposure is exposed for a shorter time and includes less motion blur.

In such an example, short exposure frame can be the anchor frame. Motion blur can refer to the opposite of crispness of the person in motion between exposures. The present motion estimation logic in HDR systems (e.g., hardware) uses differences between pixels in exposure compensated frames. The pixels with high difference are treated as motion and low difference are treated as static. Changes in pixels (e.g., differences in pixels) due to flicker after exposure compensation is high even at pixels which are static. In such an example, the flicker artifact is treated as motion. For the same reason, while blending the different exposure frames, most of the pixels will be picked from the anchor frame. Further, the estimation motion map is a binary map which indicates whether a pixel is associated with motion or a static object.

Systems which correct the flicker in the short frame and pass it into the motion estimation block can correct for flicker. Because the flicker is removed, the motion estimation logic can determine real motion as motion and can avoid incorrectly determining flicker as motion.

Systems, apparatuses, methods (also referred to as processes), and computer-readable media (collectively referred to herein as “systems and techniques”) are described herein for flicker compensation to improve HDR in mixed light environments. The systems and techniques herein can improve image quality by removing artifacts resulting from flicker in HDR images with less noise. Many HDR systems use images with shorter exposure settings as an anchor frame upon which the HDR system removes artifacts by blending the image with a shorter exposure setting with an image of a longer (e.g., higher) exposure setting. Current HDR systems incorrectly detect flicker as being motion in an image. Systems and techniques herein can differentiate between actual motion of subjects within images and flicker.

In some aspects, the systems and techniques can include obtaining a first image and a second image. For example, the first image and the second image can be captured by a camera. The camera can use various exposure settings to capture the first image and the second image. For example, the camera can capture the first image using a shorter exposure setting (referred to as short exposure frame or short frame) than the second image. The camera can further capture the second image using a longer exposure setting (referred to as the long exposure frame or long frame) than the first image.

In some aspects, the first image and the second image can include artifacts associated with flicker. For example, when the camera captures images in a mixed light environment (e.g., an environment with natural light such as the sun and artificial light such as an LED), flicker can become visible in the images. In some aspects, the systems and techniques can include generating various maps to compensate and correct for flicker. For example, the systems and techniques can include a map generator for generating a flicker map (also referred to as a gain ratio map or short to long frame ratio map), an outdoor exclusion map, and a local motion map (also referred to as an irregularity map). The map generator can generate the maps based on a short frame and a long frame.

The flicker map can be a matrix (or other data representation, such as an array) representing flicker associated with pixels of the short frame and the long frame. For example, the flicker map can be a matrix associated with relationships between the short frame and the long frame. The flicker map can include values such as ratios of pixel values of the short frame to pixel values of the long frame, and vice versa (e.g., ratio of pixel values of the long frame to pixel values of the short frame). In some aspects, the systems and techniques can estimate flicker of the short frame, and the long frame based on a ratio of light intensities of corresponding pixels between the short frame and the long frame (referred to as the flicker ratio or short to long frame ratio).

The outdoor exclusion map can be a matrix associated with a region of the short frame or the long frame having pixels associated with natural lighting. The systems and techniques can include determining the regions of the short frame and the long frame associated with the natural lighting, and excluding pixels of the regions associated with natural lighting from flicker correction techniques. In some aspects, the outdoor exclusion map can be used to detect when a region or a pixel in an image is outdoor using multiple parameters such as the intensity of the pixel, temporal variation of pixel values, neighboring pixels, etc.). The intensity value of pixels can be used to determine whether the pixel is close to saturation (e.g., a bright value or high value). The variation of the same pixel values over consecutive frames can be checked to determine whether there is a pattern of flicker. Neighboring pixel classification can be checked to determine whether there is a pattern of flicker.

The local motion map can be a matrix associated with pixels of the short frame and the long frame that deviate because of contrast in border regions of the short frame and the long frame. For example, the short frame and the long frame can be captured by the same camera and depict the same scene. Because the long frame is captured over a longer period of time (e.g., longer exposure setting) differences can be present in the short frame and the long frame. A shift in position or orientation of the camera capturing the short frame and the long frame can produce differences in the short frame and the long frame. The motion map can be a binary image indicating whether a pixel is associated with an object in motion or a static object in a frame. Differences between the exposure compensation short frame and long frame can be determined and the differences can be compared to a threshold. Pixels associated with values greater than the threshold can be associated with motion and others are associated with static objects. Further, because long frames use a longer exposure setting, long frames can include more detail for darker areas of a scene. Deviations can become visible between the short frame and long frame in regions of the short frame with low light intensity or in regions of the long frame with high light intensity. The differences in the short frame and the long frame (also referred to as irregularities) can be represented as artifacts or differing pixel values. Deviations can be determined between exposure compensated short and long frames. Motion can be detected when there is local motion in the scene or a capturing device (e.g., a camera) moves relative to the scene.

The local motion map can be a matrix of values associated with the differences in the short frame and the long frame. Further, subjects in the scene depicted in the short frame and long frame (e.g., a person/object being photographed) or light sources can move or fluctuate during the difference in exposure time for capturing the short frame and the long frame resulting in different pixel values or varying transitions of pixel values (e.g., different contrast) between the short frame and the long frame. The systems and techniques can include generating the local motion map to include values associated with the irregularities indicating whether a region of the short frame and long frame is irregular (also referred to as invalid). The systems and techniques can include using various inpainting techniques to replace or modify pixel values associated with irregular regions of the short frame and the long frame. For example, as further described below, the inpainting techniques can use a final gain map associated with the flicker map, the outdoor exclusion map, and the local motion map to modify pixels of the short frame (e.g., when the short frame is a reference frame) or the long frame (e.g., when the long frame is a reference frame).

The systems and techniques can include generating a final gain map based on the flicker map, the outdoor exclusion map, and the local motion map. The final gain map can be a matrix of values associated with the flicker of the short frame including information associated with which regions of the short frame or the long frame to exclude from flicker correction and compensation. The systems and techniques can use the final gain map to modify a reference frame (e.g., one of the short frame or the long frame).

The systems and techniques can use the modified reference frame (for example, the modified short frame) with the long frame to estimate motion. For example, when the reference frame is the short frame, the modified short frame can be used with the long frame to determine motion depicted in a scene. The systems and techniques can include generating a motion weight map associated with the motion. For example, the motion weight map can include values associated with motion of objects in a scene captured in the modified reference frame. In such an example, the motion weight map can include values corresponding to pixels of the modified reference frame (e.g., the modified short frame) and values corresponding to pixels of the long frame. For example, the values of the motion weight map can increase based on an amount of motion (e.g., how fast an object was moving) captured in the modified reference frame. The output of the motion estimation block can be the motion weights. The motion map can include a binary image indicating whether a pixel is associated with motion or a static object. Motion weights can be determined from a non-thresholded motion map. The pixels which include motion can include lower weightage to pick from long, and vice versa (e.g., static pixels have equal weightage to pixel from either short or long, so that the HDR block selects from a frame for High dynamic range depending on high-light and low-light weights).

The systems and techniques can generate low light weights and high light weights using the long frame and the short frame. In some examples, the systems and techniques can generate a map associated with (e.g., including) the low light weights and a map associated with (e.g., including) the high light weights. The low light weights and the high light weights can be values associated with the light intensity of pixels of the long frame and the short frame. The light intensity can be represented as pixel values of the pixels. For example, the low light weights can be higher for pixels of the long frame than pixels of the short frame. In such an example, because the long frame was captured using a longer exposure time (e.g., longer exposure setting) than the short frame, an image sensor used to capture the long frame can receive more light resulting in more detail for darker scenes, which are represented in the long frame. In another example, the high light weights can be higher for pixels of the short frame than pixels of the long frame. In such an example, because the short frame was captured using a shorter exposure time (e.g., shorter exposure setting) than the long frame, high light intensity is less likely to cause the short frame to lose detail from becoming over washed by the light (e.g., detail of a scene not present in an image because of the light intensity).

In some examples, the systems and techniques can process the short frame and the long frame to determine high light intensity weights associated with the short frame and the long frame. In such an example, the high light intensity weights can include larger weight values for pixels of the short frame than corresponding pixels of the long frame when a light intensity of the pixels of the short frame exceed a brightness threshold. In further examples, the systems and techniques can process the short frame and the long frame to determine low light intensity weights associated with the short frame and the long frame. In such an example, the low light intensity weights can include larger weight values for pixels of the long frame than corresponding pixels of the short frame when a light intensity of the pixels of the long frame are equal to or below the brightness threshold.

In some aspects, the systems and techniques generate a blended weight map associated with (e.g., including) the low light weights, the high light weights, and the motion weights. In some examples, the blended weight map is a matrix of values (e.g., weights) representing low light weights, the high light weights, and the motion weights associated with pixels of the reference frame. The systems and techniques can use the blended weight map to modify pixels of the reference frame (e.g., the short frame). Modifications to the pixels of the reference frame can include adjusting pixel values of the reference frame. In some examples, the systems and techniques can include fusing portions of the short frame, and the long frame based on the blended weight map. to modify the pixel values of the reference frame. The systems and techniques can use various HDR fusion techniques to generate a fused output frame associated with the short frame, the long frame, and the blended weight map.

Various aspects of the application will be described with respect to the figures below.

FIG. 1 is a block diagram illustrating an example architecture of an image processing system 100. The image processing system 100 includes various components that are used to capture and process images, such as an image of a scene 110. The image processing system 100 can capture image frames (e.g., still images or video frames). In some cases, the lens 115 and image sensor 130 can be associated with an optical axis. In one illustrative example, the photosensitive area of the image sensor 130 (e.g., the photodiodes) and the lens 115 can both be centered on the optical axis.

In some examples, the lens 115 of the image processing system 100 faces a scene 110 and receives light from the scene 110. The lens 115 bends incoming light from the scene toward the image sensor 130. The light received by the lens 115 then passes through an aperture of the image processing system 100. In some cases, the aperture (e.g., the aperture size) is controlled by one or more control mechanisms 120. In other cases, the aperture can have a fixed size.

The one or more control mechanisms 120 can control exposure, focus, and/or zoom based on information from the image sensor 130 and/or information from the image processor 150. In some cases, the one or more control mechanisms 120 can include multiple mechanisms and components. For example, the control mechanisms 120 can include one or more exposure control mechanisms 125A, one or more focus control mechanisms 125B, and/or one or more zoom control mechanisms 125C. The one or more control mechanisms 120 may also include additional control mechanisms besides those illustrated in FIG. 1. For example, in some cases, the one or more control mechanisms 120 can include control mechanisms for controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting the focus. In some cases, additional lenses may be included in the image processing system 100. For example, the image processing system 100 can include one or more microlenses over each photodiode of the image sensor 130. The microlenses can each bend the light received from the lens 115 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and the focus control mechanism 125B.

The exposure control mechanism 125A of the control mechanisms 120 can obtain an exposure setting. In some cases, the exposure control mechanism 125A stores the exposure setting in a memory register. Based on the exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, the image processing system 100 can include a wide angle image sensor with a low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

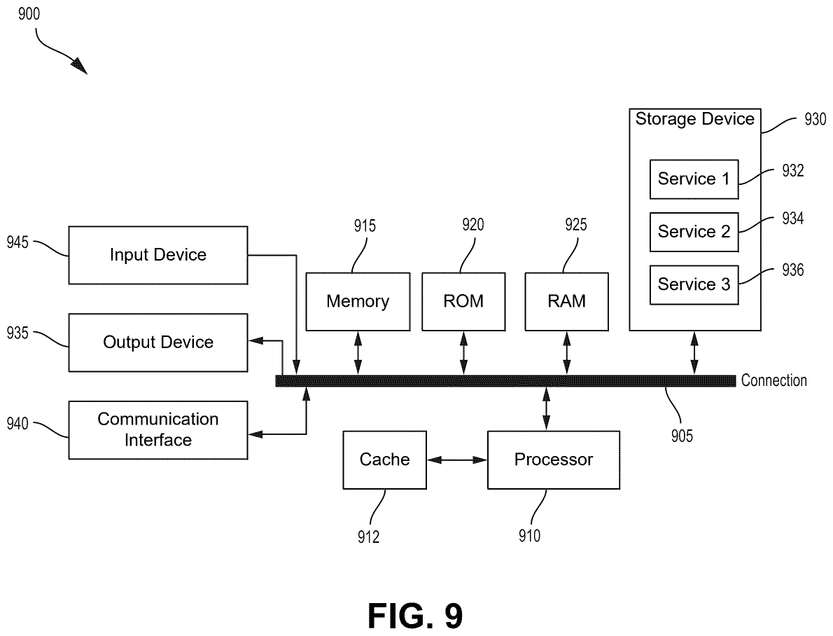

The image processor 150 may include one or more processors, such as one or more image signal processors (ISPs) (including ISP 154), one or more host processors (including host processor 152), and/or one or more of any other type of processor discussed with respect to the computing system 900 of FIG. 9. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140, read-only memory (ROM) 145, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or any combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image processing system 100 and one or more peripheral devices, over which the image processing system 100 may receive data from the one or more peripheral device and/or transmit data to the one or more peripheral devices. The I/O devices 160 may include one or more wireless transceivers that enable a wireless connection between the image processing system 100 and one or more peripheral devices, over which the image processing system 100 may receive data from the one or more peripheral device and/or transmit data to the one or more peripheral devices. The peripheral devices may include any of the previously-discussed types of the I/O devices 160 and may themselves be considered I/O devices 160 once they are coupled to the ports, jacks, wireless transceivers, or other wired and/or wireless connectors.

In some cases, the image processing system 100 may be a single device. In some cases, the image processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A. In some examples, the image processing system 100 can include one or more wireless transceivers for wireless communications, such as cellular network communications, 802.11 wi-fi communications, wireless local area network (WLAN) communications, or some combination thereof.

The image processing system 100 can be part of, or implemented by, a single computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

The image capture device 105A and the image processing device 105B can be part of the same electronic device or different electronic devices. In some implementations, the image capture device 105A and the image processing device 105B can be different devices. For instance, the image capture device 105A can include a camera device and the image processing device 105B can include a computing device, such as a mobile device, a desktop computer, a smartphone, a smart television, a game console, or other computing device.

While the image processing system 100 is shown to include certain components, one of ordinary skill will appreciate that the image processing system 100 can include more components than those shown in FIG. 1. The components of the image processing system 100 can include software, hardware, or one or more combinations of software and hardware. For example, in some implementations, the components of the image processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image processing system 100.

In some examples, the computing system 900 shown in FIG. 9 and further described below can include the image processing system 100, the image capture device 105A, the image processing device 105B, or a combination thereof.

In some examples, the image processing system 100 can create an HDR image using multiple image frames with different exposures. For example, the image processing system 100 can create an HDR image using a short exposure (SE) image, a medium exposure (ME) image, and a long exposure (LE) image. As another example, the image processing system 100 can create an HDR image using an SE image and an LE image. In some cases, the image processing system 100 can write the different image frames from one or more camera frontend engines to a memory device, such as a DDR memory device or any other memory device. A post-processing engine can then retrieve the image frames and fuse (e.g., merge, combine) them into a single image. As previously explained, the different write and read operations used to create the HDR image can result in significant power and bandwidth consumption.

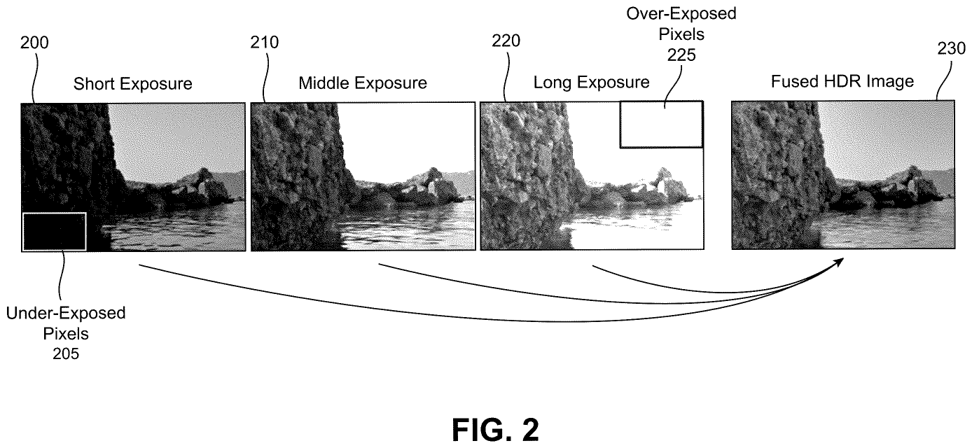

As previously explained, when creating an HDR image, over-exposed pixels of a long exposure image and under-exposed pixels of a short exposure image generally do not contribute to the final HDR image produced by the image processing system 100. For example, FIG. 2 illustrates multiple images with different exposures used to create a fused HDR image (e.g., HDR image 230). In particular, FIG. 2 shows a short exposure image 200, a medium exposure image 210, a long exposure image 220, and an HDR image 230 generated by combining or fusing together the short exposure image 200, the medium exposure image 210, and the long exposure image 220. The short exposure image 200 includes under-exposed pixels 205, and the long exposure image 220 includes over-exposed pixels 225.

As shown in FIG. 2, the under-exposed pixels 205 in the short exposure image 200 and the over-exposed pixels 225 in the long exposure image 220 do not contribute to the pixels of the HDR image 230. In some cases, when creating the HDR image 230, the image processing system 100 writes the under-exposed pixels 205 in the short exposure image 200 and the over-exposed pixels 225 in the long exposure image 220 from a camera frontend engine(s) of the image processing system 100 to a memory device, reads them back (e.g., via an offline image processing engine) from the memory device, and processes the pixels of the three images (e.g., short exposure image 200, middle exposure image 210, and long exposure image 220) to create the HDR image 230. The operations to read, write, and process the under-exposed pixels 205 in the short exposure image 200 and the over-exposed pixels 225 in the long exposure image 220 contribute to the overall power and bandwidth consumption of the image processing system 100 when creating the HDR image 230, even though such pixels do not contribute to the HDR image 230.

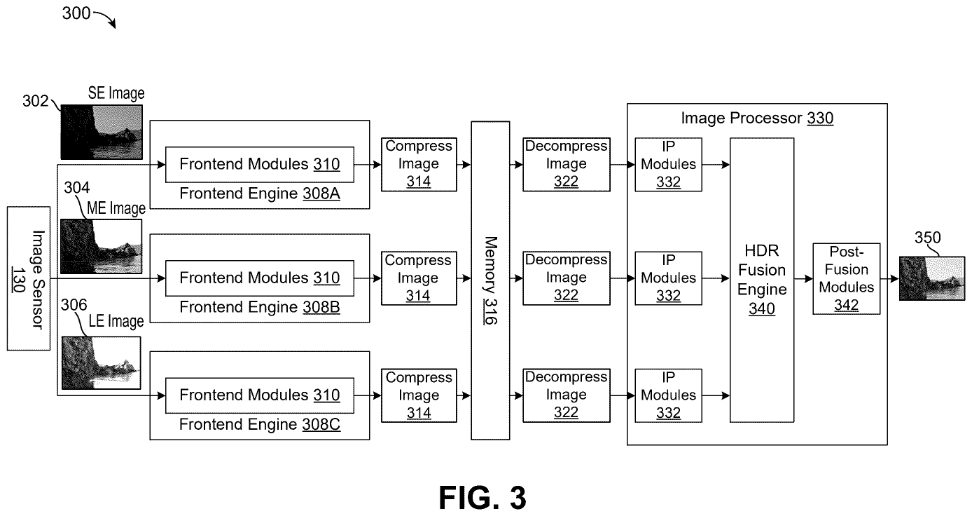

FIG. 3 is a block diagram illustrating an example system 300 for generating an HDR image 350, in accordance with aspects of the present disclosure. In this example, the system 300 generates an HDR image 350 using three images with different exposures. As shown, the image sensor 130 can capture a short-exposure (SE) image 302 of a scene, a medium-exposure (ME) image 304 of the scene, and a long-exposure (LE) image 306 of the scene. The SE image 302 can include an image with an exposure time below a threshold, the ME image 304 can include an image with an exposure time above a minimum threshold and below a maximum threshold (and/or within a range of exposure times), and the LE image 306 can include an image with an exposure time above a threshold. Moreover, the exposure time of the SE image 302 is less than the exposure time of the ME image 304, and the exposure time of the ME image 304 is less than the exposure time of the LE image 306. In this illustrative example, the camera frontend engines includes a camera frontend engine 308A for processing the SE image 302, a camera frontend engine 308B for processing the ME image 304, and a camera frontend engine 308C for processing the LE image 306.

The image sensor 130 can provide the SE image 302, the ME image 304, and the LE image 306 to the camera frontend engines 308A, 308B, 308C (collectively 308) for processing. While shown as three separate frontend engines 308, it may be understood that system 300 may utilize one camera frontend engine or multiple camera frontend engines. For example, in some cases, the camera frontend engine 308 can include a single camera frontend engine and, in other cases, the camera frontend engines 308 can include multiple camera frontend modules 310.

The camera frontend engines 308 may include one or more frontend modules 310 which can apply one or more pre-processing operations to the captured SE image 302, ME image 304, and LE image 306. While one frontend module 310 is shown per frontend engine 308, it may be understood that the frontend engines may have nay number of frontend modules 310. The pre-processing operations can include, for example and without limitation, a pixel brightness transformation (e.g., brightness correction, grey scale transformation, etc.), color space conversion, geometric transformation (e.g., rotation, scaling, translation, affine transformation, resizing, etc.), image filtering (e.g., image and/or edge smoothing and/or enhancement, denoising, image sharpening, etc.), image warping, image segmentation, image restoration, image enhancement, lens shading, color correction, black level adjustment, lens distortion correction, faulty pixel replacement, de-mosaicking, color balancing, compression, interpolation, any other image pre-processing operations, and/or a combination thereof.

Once pre-processed, the camera frontend engines 308 (or another component of the image processing system 100) can perform image compression 314 to compress the pre-processed SE image 302, ME image 304, and LE image 306. In some cases, the image compression 314 can include Bayer pattern compression. In some examples, the image compression 314 can include Huffman coding. In some cases, the image compression 314 can separately compresses each of the channels (e.g., red, green, and blue) of the SE image 302, the ME image 304 of the channels of the LE image 306. The compressed images may be written to memory 316. The memory 316 can include any memory device. For example, in some cases, the memory 316 can include the RAM 140 of the image processing system 100 shown in FIG. 1. In other cases, the memory 316 can include any of the memory device of computing system 900 shown in FIG. 9. In one illustrative example, the memory 316 can include a DDR memory device. In other illustrative examples, the memory 316 can include any other type of memory device.

An image processor 330 of the image processing system 100 can retrieve the compressed SE image 302, the compressed ME image 304, and the compressed LE image 306 from the memory 316 and perform image decompression 322 on the compressed SE image 302, the compressed ME image 304, and the compressed LE image 306. The image processor 330 can include one or more processors. Moreover, the image processor 330 can include any type of processors such as, for example, a CPU, a DSP, an ISP, an application-specific integrated circuit, etc. In one illustrative example, the image processor 330 can include an ISP, such as ISP 154 shown in FIG. 1.

The image processor 330 may perform one or more processing operations on the decompressed SE image 302, the decompressed ME image 304, and the decompressed LE image 306 via one or more image processing (IP) modules 332. While one IP module 332 is shown for processing each of the decompressed SE image 302, the decompressed ME image 304, and the decompressed LE image 306, it may be understood that any number of IP modules 332 may be used. The one or more processing operations can include, for example and without limitation, a filtering operation, a blending operation (e.g., blending pixel values) and/or interpolation operation, a pixel brightness transformation (e.g., brightness correction, grey scale transformation, etc.), a color space conversion, a geometric transformation (e.g., rotation, scaling, translation, affine transformation, resizing, etc.), a cropping operation, a white balancing operation, a denoising operation, an image sharpening operation, chroma sampling, image scaling, a lens correction operation, a segmentation operation, a filtering operation (e.g., filtering in terms of adjustments to the quality of the image in terms of contrast, noise, texture, resolution, etc.), an image warping operation, an image restoration operation, a lens shading operation, a lens distortion correction operation, a faulty pixel replacement operation, a demosaicking operation, a color balancing operation, a smoothing operation, an image enhancement operation, an operation for implementing an image effect or stylistic adjustment, a feature enhancement operation, an image scaling or resizing operation, a color correction operation, a black level adjustment operation, a linearization operation, a gamma correction operation, any other image post-processing operations, and/or a combination thereof.

In some cases, the image processor 330 can then perform HDR image fusion (e.g., by the HDR fusion engine 340) to fuse the decompressed SE image 302, decompressed ME image 304, and a decompressed LE image 306 into a fused HDR image. For example, the processor 330 can combine/merge the decompressed SE image 302, decompressed ME image 304, and a decompressed LE image 306 into a single, fused HDR image that has a higher dynamic range than either the SE image 302, the ME image 304, or the LE image 306.

After the HDR image fusion (e.g., by the HDR fusion engine 340), the image processor 330, in some cases, may perform post-fusion processing operations on the fused HDR image via post fusion modules 342. While one post fusion modules 342 is shown, it may be understood that any number of post fusion modules 342 may be used. The one or more post-fusion processing operations can include, for example and without limitation, a filtering operation, a blending operation (e.g., blending pixel values) and/or interpolation operation, a pixel brightness transformation (e.g., brightness correction, grey scale transformation, etc.), a color space conversion, a geometric transformation (e.g., rotation, scaling, translation, affine transformation, resizing, etc.), a cropping operation, a white balancing operation, a denoising operation, an image sharpening operation, chroma sampling, image scaling, a lens correction operation, a segmentation operation, a filtering operation (e.g., filtering in terms of adjustments to the quality of the image in terms of contrast, noise, texture, resolution, etc.), an image warping operation, an image restoration operation, a lens shading operation, a lens distortion correction operation, a faulty pixel replacement operation, a demosaicking operation, a color balancing operation, a smoothing operation, an image enhancement operation, an operation for implementing an image effect or stylistic adjustment, a feature enhancement operation, an image scaling or resizing operation, a color correction operation, a black level adjustment operation, a linearization operation, a gamma correction operation, any other image post-processing operations, and/or a combination thereof. The processor 330 may output the HDR image 350 based on the post-fusion processing operations performed on the fused HDR image.

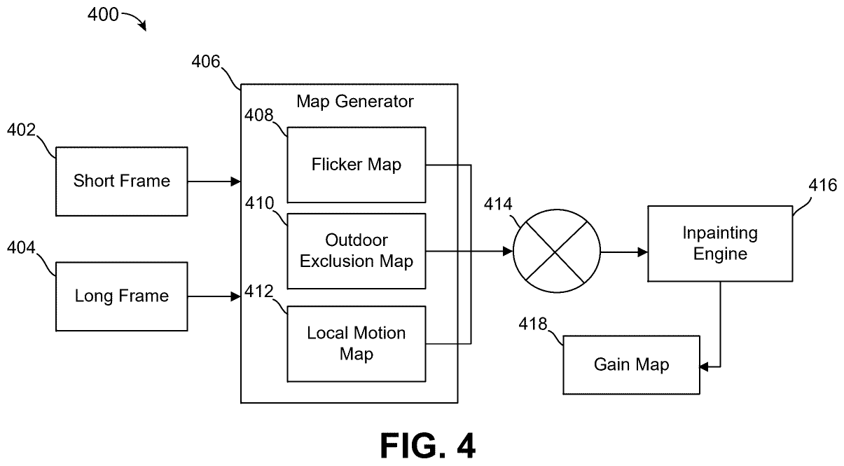

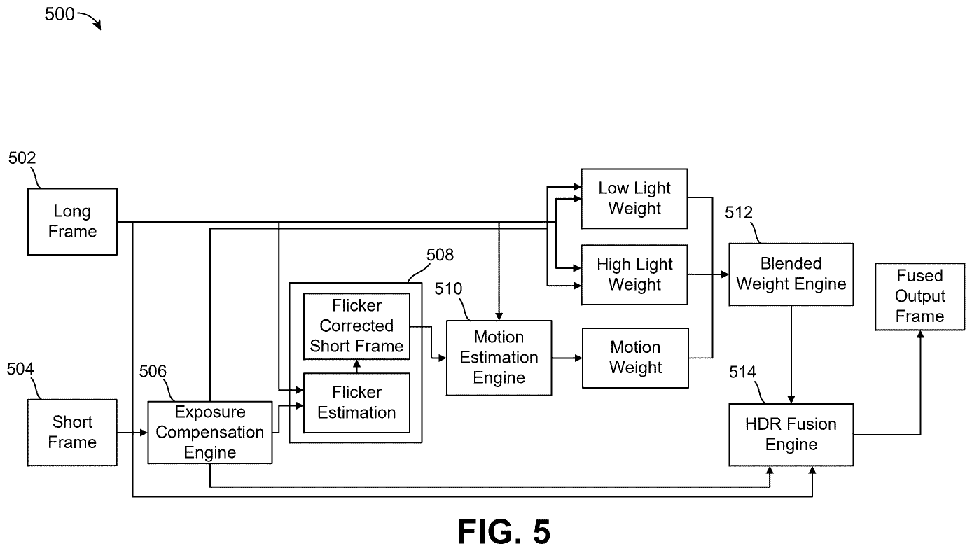

In accordance with aspects of the present disclosure, systems and techniques for flicker compensation and correction can be used to correct or compensate pixel values of a reference frame for flicker. The systems and techniques can include using the modified reference frame to determine motion in scenes of one or more image frames. The systems and techniques can include generating a motion weight map based in part on the modified reference frame. The image processing system 100 of FIG. 1 can be used to perform the various HDR fusion and post-fusion operations of the descriptions of FIG. 2 and FIG. 3. The image processing system 100 can further be used to perform the flicker correction and compensation operations described in the description of FIG. 4 and the description of FIG. 5.

FIG. 4 is a block diagram illustrating a flicker correction engine 400 for flicker gain map estimation. The example flicker correction engine 400 includes a map generator 406. The map generator 406 can receive a short frame 402 and a long frame 404. For example, the short frame and the second image can be captured by a camera. The camera can use various exposure settings to capture the first image and the second image. For example, the camera can capture the short frame using a shorter exposure setting than the long frame. The camera can capture the long frame using a longer exposure setting than the short frame. In some examples, the map generator 406 can use a low resolution version of the short frame and the long frame. For example, the map generator 406 can obtain a low resolution version of the short frame and the long frame to reduce computational costs when generating maps.

The short frame and the long frame can include artifacts associated with flicker. For example, when the camera captures images in a mixed light environment (e.g., an environment with natural light such as the sun and artificial light such as an LED), flicker can become visible in the images. In some examples, flicker is visible as a band of spatial variation of the short frame and long frame. The spatial variation can be due to the exposure delay among pixel rows of a camera when capturing the short frame and long frame. The map generator 406 can generate various maps to compensate and correct for flicker. The spatial variation can be based on a delay in a start of exposure among pixel rows of a camera sensor. The delay can create variation in pixel intensity recorded by pixels in different rows. The variation/flicker can be present in both or only one exposure frame (e.g., one of the long frame and the short frame.

The systems and techniques can include generating various maps to compensate and correct for flicker. For example, the systems and techniques can include a map generator for generating a flicker map (also referred to as a gain ratio map or short to long frame ratio map), an outdoor exclusion map, and a local motion map. An irregular map can include a flicker map. The pixels of the irregular map can be referred to as irregular pixels. The estimation of flicker can be based on information from neighboring pixels to determine irregular pixel gain values. The map generator can generate the maps based on a short frame and a long frame. For example, a flicker map is an image which includes flicker content in the image (e.g., ideal frame×flicker map=captured flicker frame. A gain ratio map can include a correction map which when multiplied with the flickered frame provides a flicker free image (e.g., captured flicker frame multiplied by a gain map=flicker-corrected frame). In some examples, the flicker-corrected frame can be the same frame as an ideal frame. A short to long ratio map can include a simple calculation of short frame/long frame. In some examples, the simple calculation for flicker frame can be or include flicker map=(short to long ratio map multiplied by an exposure ratio)−1, where short to long ratio map=Short Frame/Long Frame.

The map generator 406 can generate maps associated with short frame and the long frame. For example, the map generator 406 can generate a flicker map 408 (also referred to as a gain ratio map or short to long frame ratio map), an outdoor exclusion map 410, and a local motion map 412. The maps generated by the map generator can be matrices of values associated with pixels of the short frame 402 and pixels of the long frame 404.

For example, the flicker map 408 can be a matrix representing flicker associated with pixels of the short frame 402 and the long frame 404. In some examples, the flicker map 408 is a matrix including ratios of pixel values of the short frame 402 to pixel values of the long frame 404. In some examples, the map generator 406 can process the short frame 402 and the long frame 404 to determine flicker of the short frame 402 and flicker of the long frame. In further examples, the map generator 406 can process the short frame 402 and the long frame 404 to determine a flicker ratio of the short frame 402 to the long frame 404. For example, the short frame can be represented by the equation: Iₛₕₒᵣₜ=T_{shortExpTime}*I₀(1+A sin(ωt)*Gₛₕₒᵣₜ. Element Iₛₕₒᵣₜ can represent the light intensity of the short frame. For example, Iₛₕₒᵣₜ can be a matrix including values associated with the light intensity of pixels of the short frame.

T_{shortExpTime} represents the exposure time used to capture the short frame. I₀ represents an average light intensity of a DC component of the flicker (e.g., a captured light intensity when there is not an AC light source such as illumination from a DC light source or sunlight). I₀ can include a matrix associated with scene content information. Gₛₕₒᵣₜ Represents the gain of the short frame. Further, the flicker can be represented as A sin(ωt) with A being a constant. The long frame can be represented by the equation: I_{Long}=T_{LongExpTime}*I₀*G_{long} with I_{Long} representing light intensity of the long frame (e.g., light intensity captured in the long frame for a scene). In some examples, I_{Long} is a matrix including values associated with the light intensity of pixels of the long frame. T_{LongExpTime} represents the exposure time used to capture the long frame with T_{LongExpTime}>T_{shortExpTime}. Further, G_{long} represents the gain of the long frame.

In some examples, the map generator 406 can determine an exposure ratio associated with the short frame and the long frame. For example, the exposure ratio (K) can be represented as: Gₛₕₒᵣₜ*T_{shortExpTime}*K=G_{long}*T_{LongExpTime}. The map generator 406 can determine flicker associated with the short frame (e.g., short flicker) using the equations for the short frame (Iₛₕₒᵣₜ=T_{shortExpTime}*I₀(1+A sin(ωt))*Gₛₕₒᵣₜ), the equation of the long frame (I_{Long}=T_{LongExpTime}*I₀*G_{long}), and the exposure ratio equation.

For example, the previously mentioned equations can be rewritten to be represented as

$$( K * \frac{{I}_{short}}{{I}_{Long}} ) - 1 = A sin ( ω t ) ) .$$

When solving to remove the short flicker (A sin(ωt))), the map generator 406 can use the equation I_{FlickerFreeShort}=T_{shortExpTime}*I₀*Gₛₕₒᵣₜ with I_{FlickerFreeShort} representing the light intensity of the short frame without the short flicker. I_{FlickerFreeShort} can further be represented as

$${I}_{FlickerFreeShort} = {I}_{S hort} * \frac{1}{1 + ( K * \frac{{I}_{short}}{{I}_{L o n g}} - 1 )} with$$

$$\frac{1}{1 + ( K * \frac{{I}_{Short}}{{I}_{Long}} - 1 )}$$

representing a flicker correction gain map.

The map generator 406 can generate an outdoor exclusion map 410 associated with one or more regions of the short frame or the long frame having pixels associated with natural lighting. The map generator 406 can determine, based on pixel values of the short frame, regions of the short frame associated with natural lighting. The map generator 406 can generate an outdoor exclusion map representing pixels of the short frame 402 that should be excluded from modification or adjustment when correcting for short flicker.

The map generator 406 can generate a local motion map 412 associated with pixels of the short frame and the long frame that deviate from one another. In some examples, the local motion map includes details of pixels associated with movement in a scene. For example, because the long frame is captured over a longer period of time (e.g., longer exposure setting) differences can be present in the short frame and the long frame. In some examples, the differences are visible in border regions between areas of the short frame and the long frame with high light intensity and areas with low light intensity (e.g., areas of the short frame and the long frame with higher contrast). Local motion can include when an object in a scene is moving, whereas global motion can include changes in position or orientation of the camera because the entire captured image is shifted in one direction (e.g., direction of movement of the camera). Further, because long frames use a longer exposure setting than short frames, long frames can include more detail for darker areas. Deviations can become visible between the short frame and long frame in regions of the short frame with low light intensity or in regions of the long frame with high light intensity. The local motion map 412 can be a matrix of values associated with the differences (e.g., movement of pixels, artifacts, different pixel values associated with light intensity, etc.) between the short frame and the long frame.

The map generator 406, or a component thereof, can generate a final gain map 414 based on the flicker map 408, the outdoor exclusion map 410, and the local motion map 412. The final gain map 414 can include values (e.g., a matrix of values or other data structure including values) associated with the flicker of the short frame. In some examples, the final gain map 414 can further include values associated with the flicker of the long frame. Additionally, the final gain map can include values associated with regions of the short frame to exclude from flicker correction and compensation (e.g., the regions of the short frame associated with outdoors and natural lighting). An inpainting engine 416 can use the final gain map and various inpainting techniques to modify the short frame (e.g., by adjusting pixel values of the short frame). The inpainting engine can generate a modified gain map 418 associated with the modified short frame. The inpainting engine can be used to in-paint the flicker map in irregular regions. The enhanced flicker map can be used to determine the modified gain map 418.

FIG. 5 is a block diagram illustrating an example system 500 for flicker compensation of HDR images. FIG. 5 includes an exposure compensation engine 506, a flicker correction engine 508, a motion estimation engine 510, a blended weight engine 512 and an HDR fusion engine 514. The exposure compensation engine 506 can receive a short frame 504. The exposure compensation engine 506 can perform various exposure compensation techniques using the short frame 504. For example, the exposure compensation engine 506 can perform various post-processing (e.g., after the short frame 504 has been captured by a camera) exposure compensation techniques, such as adjusting the brightness (e.g., light intensity) of the short frame (also referred to as the short exposure frame) or performing shadow adjustments of the short frame.

The exposure compensation engine 506 can include a post processing engine to adjust sensitivity of the different exposure frames to a similar sensitivity. For example, a short exposure frame can be captured at a different sensitivity than a long exposure frame (e.g., varying brightness of the frames). In one such example, the short exposure frame can be captured with an exposure time of 5 ms and a gain of 5. The sensitivity of the short exposure frame can be represented as the exposure time multiplied by the gain to equal 25. The long exposure frame can be captured using an exposure time of 20 ms and a gain of 10. The sensitivity of the long exposure frame can be represented as the exposure time multiplied by the gain to equal 200. In such an example, the short exposure frame is 8 times darker (e.g., 200 is 8 times 25) than the long exposure frame. The exposure compensation engine 506 can brighten the short exposure frame so that the short exposure frame is a similar brightness (e.g., sensitivity) as the long exposure frame.

The exposure compensation engine 506 can output an exposure compensated short frame. The flicker correction engine 508 can receive the exposure compensated short frame and the long frame 502 (also referred to as the long exposure frame). In some examples, the flicker correction engine 508 can be the flicker correction engine 400 of FIG. 4. For example, the flicker correction engine 508 can perform flicker estimation, as further described in the description of FIG. 4.

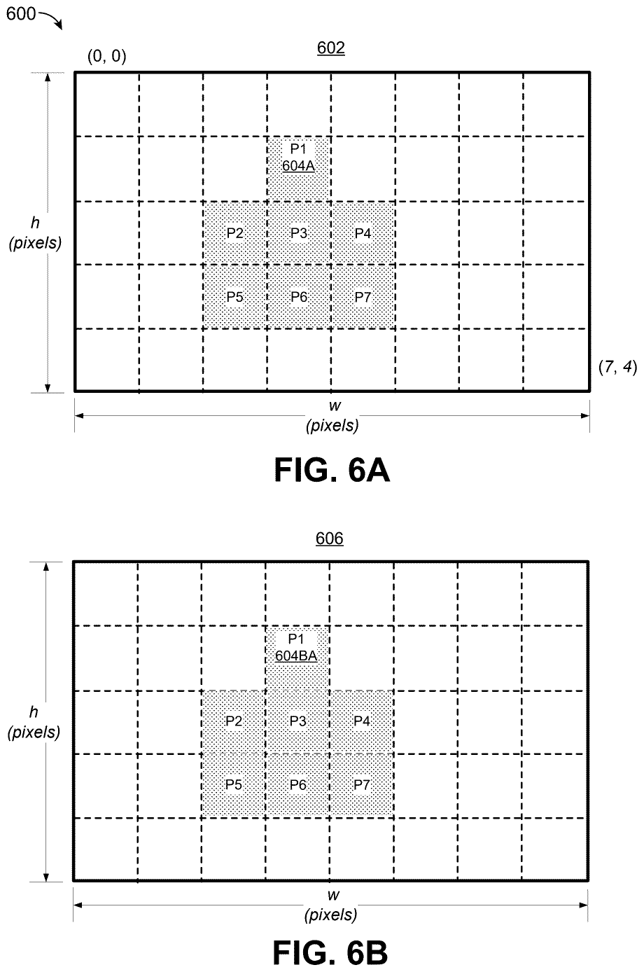

The flicker correction engine 508 can generate a modified short frame based on the flicker estimation to reduce the amount of flicker associated with the exposure corrected short frame. The motion estimation engine 510 can receive the modified short frame and the long frame 502 and determine motion associated with the modified short frame and the long frame 502. For example, the motion estimation engine 510 can determine motion based on varying light intensities of corresponding pixels of the modified short frame and the long frame 502. As used herein, corresponding pixels (or regions) between two frames refers to pixels (or regions) in common locations between the two frames, as described below with respect to FIG. 6A and FIG. 6B. In further examples, the motion estimation engine 510 can determine motion based on a shift in location of pixels from the modified short frame to the long frame 502.

The motion estimation engine 510 can generate a motion weight map. The motion weight map can be a matrix of values associated with motion determined based on a comparison of pixels of the modified short frame and the long frame 502. For example, the values of the motion weight map can be based on a distance associated with the movement of corresponding pixels in corresponding locations of the modified short frame and the long frame. In such an example, the weights of the motion weight matrix can be based on displacement distance of corresponding pixels (e.g., pixels associated with an object represented in the modified short frame and the long frame) from the modified short frame and the long frame.

The blended weight engine 512 can receive multiple weight maps. For example, the blended weight engine 512 can receive the motion weight map, a high light weight map, and a low light weight map. In some examples, the blended weight engine 512 can process the long frame 502 and the short frame 504 to determine the high light weight map and the low light weight map. In some examples, the blended weight engine 512, or another component of example system 500, can generate a map including low light weights and a map including high light weights. The low light weights and the high light weights can be values associated with the light intensity of pixels of the long frame and the short frame. The light intensity can be represented as pixel values. For example, the low light weights can be higher for pixels of the long frame than pixels of the short frame.

In some examples, the blended weight engine 512 can process the short frame and the long frame to determine high light intensity weights associated with the short frame and the long frame. In such an example, the high light intensity weights can include larger weight values for pixels of the short frame than corresponding pixels of the long frame when a light intensity of the pixels of the short frame exceed a brightness threshold (e.g., a predetermined brightness threshold). In further examples, the blended weight engine 512, or another component of example system 500, can process the short frame and the long frame to determine low light intensity weights associated with the short frame and the long frame. In such an example, when a light intensity of the pixels of the long frame are equal to or below the brightness threshold, the low light intensity weights can include larger weight values for pixels of the long frame than corresponding pixels of the short frame.

The blended weight engine 512 can generate a blended weight map including the low light weights, the high light weights, and the motion weights. In some examples, the blended weight map is a matrix of values (e.g., weights) representing low light weights and high light weights associated with the short frame 504 and the long frame 502. The blended weight map can further include values of motion weights associated with the long frame 502 and the modified short frame. The HDR fusion engine 514 can use the blended weight map and various HDR fusion techniques, such as the HDR fusion techniques described in the description of FIGS. 2-3, to modify the short frame 504. The HDR fusion engine 514 can output a fused output frame associated with the short frame 504, the long frame 502. can use the blended weight map to determine weights to modify pixels of the reference frame, such as the short frame. Modifications to the pixels of the reference frame can include adjusting pixel values of the reference frame. In some examples, the systems and techniques can include fusing portions of the short frame, and the long frame based on the blended weight map. to modify the pixel values of the reference frame. The systems and techniques can use various HDR fusion techniques to generate a fused output frame associated with the short frame, the long frame, and the blended weight map.

FIG. 6A is a diagram illustrating an example of a frame 602 or image, such as a short frame. The frame 602 includes various pixels, including pixels P1, P2, P3, P4, P5, P6, and P7 (corresponding to an object of interest) at illustrative pixel locations. By way of example, pixels P1, P2, P3, P4, P5, P6, and P7 of FIG. 6A are associated with a region of the frame 602. Frame 602 is shown with dimensions of w pixels wide by h pixels high (denoted as w×h). One of ordinary skill will understand that frame 602 can include many more pixel locations than those illustrated in FIG. 6A. For example, frame 602 can include a 4K (or ultra-high definition (UHD)) frame at a resolution of 3,840×2,160 pixels, an HD frame at a resolution of 1,920×1,080 pixels, or any other suitable frame having another resolution. A pixel P1 is shown at a pixel location 604A. Pixel location 604A can include a (w, h) pixel location of (3, 1) relative to the top-left-most pixel location of (0, 0). The pixel P1 is used for illustrative purposes and can correspond to any suitable point on the object of interest within the region, such as the point of a nose of a person.

FIG. 6B is a diagram illustrating an example of a frame 606 or image, such as a long frame (e.g., capturing a same portion of a scene as the frame 602). Frame 606 has the same corresponding pixel locations as that of frame 602 (with dimension w×h). For example, the pixels P1, P2, P3, P4, P5, P6, and P7 of the frame 606 can “correspond to” (e.g., be located in a same position with the frame as) the pixels P1, P2, P3, P4, P5, P6, and P7 of the frame 602. For example, the pixel P1 at pixel location 604B in the frame 606 corresponds to the pixel P1 at pixel location 604A in the frame 602. By way of example, pixels P1, P2, P3, P4, P5, P6, and P7 are associated with a region of the frame 606, where the region of the frame 606 corresponds to the region of the frame 602 including the pixels P1, P2, P3, P4, P5, P6, and P7 of the frame 602.

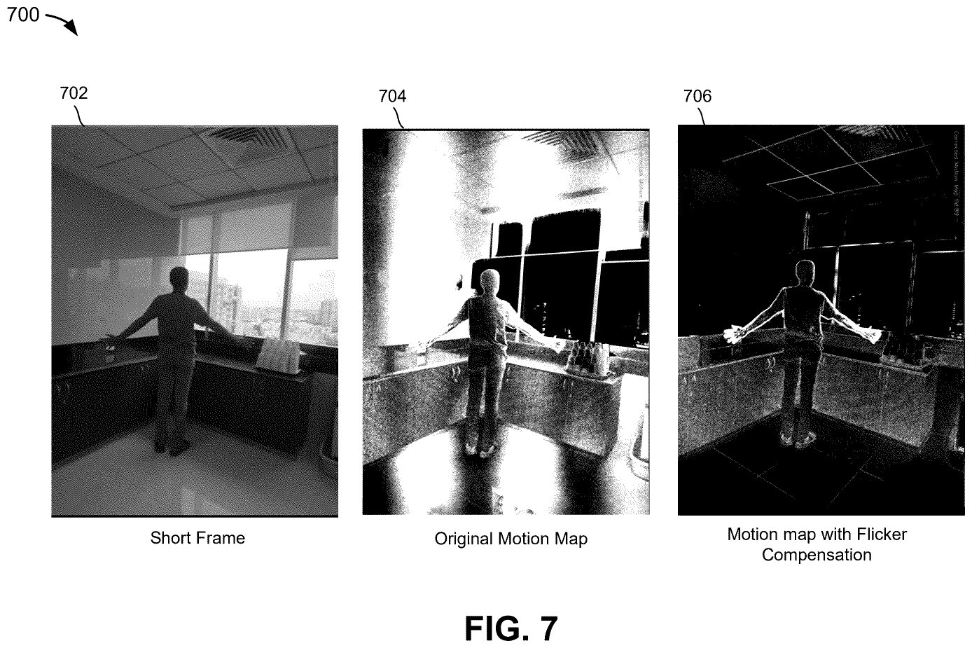

FIG. 7 is a block diagram illustrating an example short image frame 702. FIG. 7 also includes a first corresponding motion map 704 and a second corresponding motion map 706 incorporating flicker compensation techniques such as the flicker compensation techniques of FIG. 4 and FIG. 5. For example, the short image frame 702 depicts an LED operating in a dark room. The first corresponding motion map 704 does not include flicker compensation techniques. The light portions of the first corresponding motion map 704 indicates perceived motion by an HDR system. The perceived motion is inaccurate, because the perceived motion is flicker from the LED which HDR systems can incorrectly determine to be motion. The second corresponding motion map 706 is primarily dark because the second corresponding motion map 706 does not incorrectly identify the flicker from the LED to be motion.

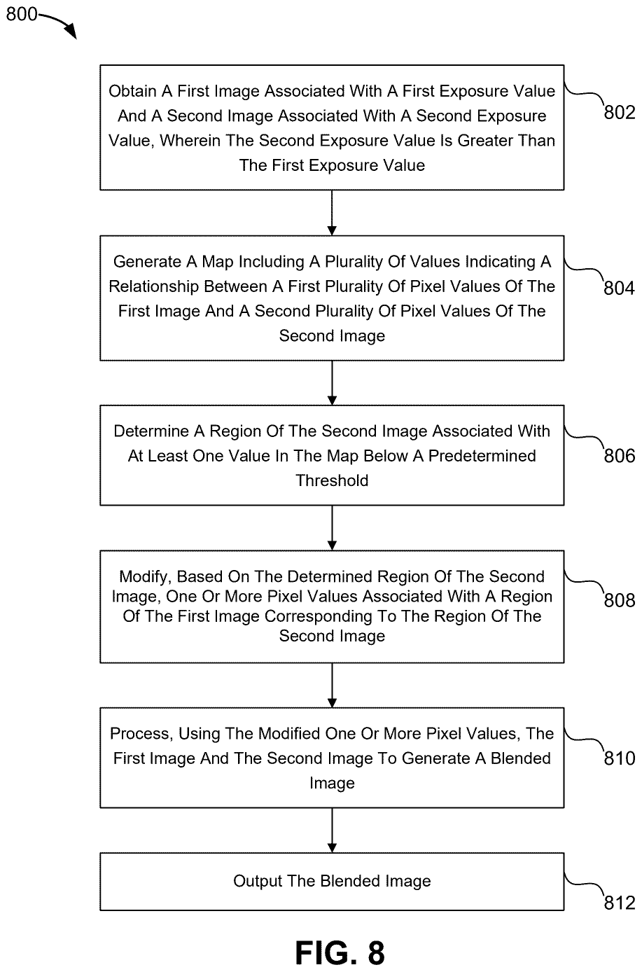

FIG. 8 is a flow diagram illustrating an example process 800 for image processing (e.g., performing flicker correction and compensation HDR images) in accordance with aspects of the present disclosure. One or more operations of process 800 can be performed by a computing device (or apparatus) or a component (e.g., a chipset, codec, etc.) of the computing device. The computing device can be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 800. The one or more operations of process 800 can be implemented as software components that are executed and run on one or more processors.

At block 802, the computing device (or component thereof) can obtain a first image associated with a first exposure value and a second image associated with a second exposure value, wherein the second exposure value is greater than the first exposure value. For example, the first exposure value and the second exposure value can be associated with exposure time of a camera generating the first image and the second image. In such an example, the first image can be generated using short exposure and the second image can be generated using long exposure. For example, the first image can be a short frame and the second image can be a long frame. The first image and the second image can be image representations of the same scene over different exposure times (e.g., exposure times corresponding to the exposure values).

At block 804, the computing device (or component thereof) can generate a map including a plurality of values indicating a relationship between a first plurality of pixel values of the first image and a second plurality of pixel values of the second image. For example, the map can include a motion map indicating movement of an object represented in the first image and the second image. For example, the first image and the second image can depict the same scene. The map can include a motion map of values representing movement of objects in the scene represented in the first image and the second image. In some examples, the plurality of values indicating the relationship between the first plurality of pixel values and the second plurality of pixel values includes a correction map associated with correction values to remove flicker of the first image or the second image.

At block 806, the computing device (or component thereof) can determine a region of the second image associated with at least one value in the map below a predetermined threshold. For example, the predetermined threshold can be a brightness threshold. The computing device (or component thereof) can compare the at least one value to the predetermined threshold to determine the at least one value is below the predetermined threshold.

At block 808, the computing device (or component thereof) can modify, based on the determined region of the second image, one or more pixel values associated with a region of the first image corresponding to the region of the second image. For example, when multiple pixel values are below the predetermined threshold, the computing device (or component thereof) can modify multiple pixel values.

At block 810, the computing device (or component thereof) can process, using the modified one or more pixel values, the first image and the second image to generate a blended image. In some examples, the computing device (or component thereof) can process the modified first image and the second image to determine motion weights associated with motion within a scene of the modified first image or the second image, wherein the motion weights include larger weight values for pixels of the modified first image associated with the motion than pixels of the modified first image not associated with the motion. In another example, the computing device (or component thereof) can process the modified first image and the second image to determine motion weights associated with motion within a scene of the modified first image or the second image, wherein the motion weights include larger weight values for pixels of the modified first image associated with the motion than pixels of the modified first image not associated with the motion.

In a further example, the computing device (or component thereof) can process the first image and the second image to determine a first light intensity weights associated with the first image and the second image. The first light intensity weights include larger weight values for pixels of the first image associated with light intensity exceeding a brightness threshold than pixels of the second image associated with light intensity exceeding the brightness threshold. For example, the first light intensity can be a high light intensity associated with pixel values with a brightness above the brightness threshold. In another example, the computing device (or component thereof) can process the first image and the second image to determine second light intensity weights associated with the first image and the second image, where the second light intensity weights include larger weights for pixels of the second image associated with light intensity below the brightness threshold than pixels of the first image associated with light intensity below the brightness threshold. In such an example, the second light intensity can be a low light intensity associated with pixel values with a brightness below a brightness threshold. In a further example, the computing device (or component thereof) can modify the one or more pixel values based on the motion weights, the first light intensity weights, and the second light intensity weights.

In another example, the computing device (or component thereof) can identify, based on the second plurality of pixel values of the second image, a second region of the second image associated with an outdoor lighting source. In a further example, the modifications of the one or more pixel values of the first plurality of pixel values excludes modification of pixel values associated with the second region. The computing device (or component thereof) can identify, based on the first plurality of pixel values of the first image or the second plurality of pixel values of the second image, one or more irregular pixel values deviating in pixel value from adjacent pixels greater than a second predetermined threshold. The computing device (or component thereof) can modify the one or more irregular pixel values based on the pixel values of the adjacent pixels.

At block 812, the computing device (or component thereof) can output the blended image. The computing device (or component thereof) can output a modified first image including the modified one or more pixel values. In some examples, the modified first image can include corrected pixel values of irregular pixels. In such an example, the irregular pixels can be based on pixel values of adjacent pixels.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 900 also includes a connection 905 that couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 can essentially be a completely self-contained computing system, containing multiple cores or processors, a bus, memory controller, cache, etc. A multi-core processor can be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 can also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc. When the code that defines such software is executed by the processor 910, the code causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for processing image data, the apparatus comprising: at least one memory; and at least one processor coupled to the at least one memory and configured to: obtain a first image associated with a first exposure value and a second image associated with a second exposure value, wherein the second exposure value is greater than the first exposure value; generate a map including a plurality of values indicating a relationship between a first plurality of pixel values of the first image and a second plurality of pixel values of the second image; determine a region of the second image associated with at least one value in the map below a predetermined threshold; and modify, based on the determined region of the second image, one or more pixel values associated with a region of the first image corresponding to the region of the second image; process, using the modified one or more pixel values, the first image and the second image to generate a blended image; and output the blended image.

Aspect 2: The apparatus of Aspect 1, wherein the map includes a motion map indicating movement of an object represented in the first image and the second image.

Aspect 3: The apparatus of any of Aspects 1 to 2, wherein the plurality of values indicating the relationship between the first plurality of pixel values and the second plurality of pixel values includes a correction map associated with correction values to remove flicker of the first image or the second image.

Aspect 4: The apparatus of any of Aspects 1 to 3, wherein the at least one processor is configured to output a modified first image including the modified one or more pixel values.

Aspect 5: The apparatus of Aspect 4, wherein the at least one processor is configured to: process the modified first image and the second image to determine motion weights associated with motion within a scene of the modified first image or the second image, wherein the motion weights include larger weight values for pixels of the modified first image associated with the motion than pixels of the modified first image not associated with the motion.

Aspect 6: The apparatus of Aspect 5, wherein the at least one processor is configured to: process the first image and the second image to determine a first light intensity weights associated with the first image and the second image, wherein the first light intensity weights include larger weight values for pixels of the first image associated with light intensity exceeding a brightness threshold than pixels of the second image associated with light intensity exceeding the brightness threshold.

Aspect 7: The apparatus of Aspect 6, wherein the at least one processor is further configured to: process the first image and the second image to determine second light intensity weights associated with the first image and the second image, wherein the second light intensity weights include larger weights for pixels of the second image associated with light intensity below the brightness threshold than pixels of the first image associated with light intensity below the brightness threshold.

Aspect 8: The apparatus of Aspect 7, wherein the at least one processor is configured to modify the one or more pixel values based on the motion weights, the first light intensity weights, and the second light intensity weights.

Aspect 9: The apparatus of any of Aspects 1 to 8, wherein the at least one processor is configured to: identify, based on the second plurality of pixel values of the second image, a second region of the second image associated with an outdoor lighting source; wherein modification of the one or more pixel values of the first plurality of pixel values excludes modification of pixel values associated with the second region.

Aspect 10: The apparatus of any of Aspects 1 to 9, wherein the at least one processor is configured to: identify, based on the first plurality of pixel values of the first image or the second plurality of pixel values of the second image, one or more irregular pixel values deviating in pixel value from adjacent pixels greater than a second predetermined threshold; and modify the one or more irregular pixel values based on the pixel values of the adjacent pixels.

Aspect 11: The apparatus of any of Aspects 1 to 10, wherein the at least one processor is configured to: obtain a third image associated with a third exposure value, wherein the third image is obtained prior to the first image and the second image; compare the first image or the second image to the third image; and modify one or more pixel values of the first image or the second image based on the comparison.

Aspect 12: The apparatus of Aspect 11, wherein the third exposure value is equal to one of the first exposure value or the second exposure value.

Aspect 13: A method comprising: obtaining a first image associated with a first exposure value and a second image associated with a second exposure value, wherein the second exposure value is greater than the first exposure value; generating a map including a plurality of values indicating a relationship between a first plurality of pixel values of the first image and a second plurality of pixel values of the second image; determining a region of the second image associated with at least one value in the map below a predetermined threshold; and modifying, based on the determined region of the second image, one or more pixel values associated with a region of the first image corresponding to the region of the second image; processing, using the modified one or more pixel values, the first image and the second image to generate a blended image; and outputting the blended image.

Aspect 14: The method of Aspect 13, wherein the map includes a motion map indicating movement of an object represented in the first image and the second image.

Aspect 15: The method of any of Aspects 13 to 14, wherein the plurality of values indicating the relationship between the first plurality of pixel values and the second plurality of pixel values includes a correction map associated with correction values to remove flicker of the first image or the second image.

Aspect 16: The method of any of Aspects 13 to 15, wherein the at least one processor is configured to output a modified first image including the modified one or more pixel values.

Aspect 17: The method of Aspect 16, comprising: processing the modified first image and the second image to determine motion weights associated with motion within a scene of the modified first image or the second image, wherein the motion weights include larger weight values for pixels of the modified first image associated with the motion than pixels of the modified first image not associated with the motion.

Aspect 18: The method of Aspect 17, comprising: processing the first image and the second image to determine a first light intensity weights associated with the first image and the second image, wherein the first light intensity weights include larger weight values for pixels of the first image associated with light intensity exceeding a brightness threshold than pixels of the second image associated with light intensity exceeding the brightness threshold.

Aspect 19: The method of Aspect 18, comprising: processing the first image and the second image to determine second light intensity weights associated with the first image and the second image, wherein the second light intensity weights include larger weights for pixels of the second image associated with light intensity below the brightness threshold than pixels of the first image associated with light intensity below the brightness threshold.

Aspect 20: The method of Aspect 19, wherein modifying the one or more pixel values is based on the motion weights, the first light intensity weights, and the second light intensity weights.

Aspect 21: The method of any of Aspects 13 to 20, comprising: identifying, based on the second plurality of pixel values of the second image, a second region of the second image associated with an outdoor lighting source; wherein modification of the one or more pixel values of the first plurality of pixel values excludes modification of pixel values associated with the second region.

Aspect 22: The method of any of Aspects 13 to 21, wherein the at least one processor is configured to: identify, based on the first plurality of pixel values of the first image or the second plurality of pixel values of the second image, one or more irregular pixel values deviating in pixel value from adjacent pixels greater than a second predetermined threshold; and modify the one or more irregular pixel values based on the pixel values of the adjacent pixels.

Aspect 23: The method of any of Aspects 13 to 22, comprising: obtaining a third image associated with a third exposure value, wherein the third image is obtained prior to the first image and the second image; comparing the first image or the second image to the third image; and modifying one or more pixel values of the first image or the second image based on the comparison.

Aspect 24: The method of Aspect 23, wherein the third exposure value is equal to one of the first exposure value or the second exposure value.

Aspect 25: An apparatus for processing image data is provided. The apparatus includes one or more means for performing operations according to any of Aspects 13 to 24.

Aspect 26: A non-transitory computer-readable medium is provided having stored thereon instructions that, when executed by at least one processor, cause the at least one processor to perform operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for processing image data, the apparatus comprising:
at least one memory; and
at least one processor coupled to the at least one memory and configured to:
obtain a first image associated with a first exposure value and a second image associated with a second exposure value, wherein the second exposure value is greater than the first exposure value;
generate a map including a plurality of values indicating a relationship between a first plurality of pixel values of the first image and a second plurality of pixel values of the second image;
determine a region of the second image associated with at least one value in the map below a predetermined threshold;
modify, based on the determined region of the second image, one or more pixel values associated with a region of the first image corresponding to the region of the second image;
process, using the modified one or more pixel values, the first image and the second image to generate a blended image; and
output the blended image.

2. The apparatus of claim 1, wherein the map includes a motion map indicating movement of an object represented in the first image and the second image.

3. The apparatus of claim 1, wherein the plurality of values indicating the relationship between the first plurality of pixel values and the second plurality of pixel values includes a correction map associated with correction values to remove flicker of the first image or the second image.

4. The apparatus of claim 1, wherein the at least one processor is configured to output a modified first image including the modified one or more pixel values.

5. The apparatus of claim 4, wherein the at least one processor is configured to:
process the modified first image and the second image to determine motion weights associated with motion within a scene of the modified first image or the second image, wherein the motion weights include larger weight values for pixels of the modified first image associated with the motion than pixels of the modified first image not associated with the motion.

6. The apparatus of claim 5, wherein the at least one processor is configured to:
process the first image and the second image to determine a first light intensity weights associated with the first image and the second image, wherein the first light intensity weights include larger weight values for pixels of the first image associated with light intensity exceeding a brightness threshold than pixels of the second image associated with light intensity exceeding the brightness threshold.

7. The apparatus of claim 6, wherein the at least one processor is further configured to:
process the first image and the second image to determine second light intensity weights associated with the first image and the second image, wherein the second light intensity weights include larger weights for pixels of the second image associated with light intensity below the brightness threshold than pixels of the first image associated with light intensity below the brightness threshold.

8. The apparatus of claim 7, wherein the at least one processor is configured to modify the one or more pixel values based on the motion weights, the first light intensity weights, and the second light intensity weights.

9. The apparatus of claim 1, wherein the at least one processor is configured to:
identify, based on the second plurality of pixel values of the second image, a second region of the second image associated with an outdoor lighting source;
wherein modification of the one or more pixel values of the first plurality of pixel values excludes modification of pixel values associated with the second region.

10. The apparatus of claim 1, wherein the at least one processor is configured to:
identify, based on the first plurality of pixel values of the first image or the second plurality of pixel values of the second image, one or more irregular pixel values deviating in pixel value from adjacent pixels greater than a second predetermined threshold; and
modify the one or more irregular pixel values based on the pixel values of the adjacent pixels.

11. The apparatus of claim 1, wherein the at least one processor is configured to:
obtain a third image associated with a third exposure value, wherein the third image is obtained prior to the first image and the second image;
compare the first image or the second image to the third image; and
modify one or more pixel values of the first image or the second image based on the comparison.

12. The apparatus of claim 11, wherein the third exposure value is equal to one of the first exposure value or the second exposure value.

13. A method comprising:
obtaining a first image associated with a first exposure value and a second image associated with a second exposure value, wherein the second exposure value is greater than the first exposure value;
generating a map including a plurality of values indicating a relationship between a first plurality of pixel values of the first image and a second plurality of pixel values of the second image;
determining a region of the second image associated with at least one value in the map below a predetermined threshold;
modifying, based on the determined region of the second image, one or more pixel values associated with a region of the first image corresponding to the region of the second image;
processing, using the modified one or more pixel values, the first image and the second image to generate a blended image; and
outputting the blended image.

14. The method of claim 13, wherein the map includes a motion map indicating movement of an object represented in the first image and the second image.

15. The method of claim 13, wherein the plurality of values indicating the relationship between the first plurality of pixel values and the second plurality of pixel values includes a correction map associated with correction values to remove flicker of the first image or the second image.

16. The method of claim 13, further comprising outputting a modified first image including the modified one or more pixel values.

17. The method of claim 16, further comprising:
processing the modified first image and the second image to determine motion weights associated with motion within a scene of the modified first image or the second image, wherein the motion weights include larger weight values for pixels of the modified first image associated with the motion than pixels of the modified first image not associated with the motion.

18. The method of claim 17, further comprising:
processing the first image and the second image to determine a first light intensity weights associated with the first image and the second image, wherein the first light intensity weights include larger weight values for pixels of the first image associated with light intensity exceeding a brightness threshold than pixels of the second image associated with light intensity exceeding the brightness threshold.

19. The method of claim 18, further comprising:
processing the first image and the second image to determine second light intensity weights associated with the first image and the second image, wherein the second light intensity weights include larger weights for pixels of the second image associated with light intensity below the brightness threshold than pixels of the first image associated with light intensity below the brightness threshold.

20. The method of claim 13, further comprising:
identifying, based on the second plurality of pixel values of the second image, a second region of the second image associated with an outdoor lighting source;
wherein modification of the one or more pixel values of the first plurality of pixel values excludes modification of pixel values associated with the second region.
